(19) United States
(12) Patent Application Publication
(10) Pub. No.: US 2003/0234029 A1
(43) Pub. Date: Dec. 25, 2003

(54) Cleaning and drying a substrate

(75) Inventor: Eric J. Bergman, Kalispell, MT (US)

Correspondence Address: PERKINS COIE LLP, POST OFFICE BOX 1208, SEATTLE, WA, 98111-1208, US

(73) Assignee: Semitool, Inc.

(21) Appl. No.: 10/608,789

(22) Filed: Jun. 26, 2003

Related U.S. Application Data
(63) Continuation-in-part of application No. 09/907,485, filed on Jul. 16, 2001.
(63) Continuation-in-part of application No. 09/907,544, filed on Jul. 16, 2001.
(63) Continuation-in-part of application No. 09/907,487, filed on Jul. 16, 2001, now Pat. No. 6,427,359.

(51) Int. Cl. B08B 7/04; B08B 3/12

(52) U.S. Cl. 134/1; 134/18; 134/30; 134/32

(57) ABSTRACT

A method of processing a semiconductor workpiece, wherein sonic agitation is applied to the workpiece during a Marangoni drying or surface tension gradient drying step. Sonic agitation is applied to the workpiece as it is withdrawn from an aqueous liquid in a process vessel, or as the aqueous liquid is drained from the process vessel. As a result, the cleaning and drying steps are performed simultaneously as a single comprehensive process, which enhances workpiece cleaning while reducing processing times, chemical volumes, and overall costs.

This Application is a Continuation-In-Part of both U.S. patent application Ser. Nos. 09/907,485 and 09/907,544, both filed on Jul. 16, 2001 and both now pending. This Application is also a Continuation-In-Part of U.S. patent application Ser. No. 09/907,487, also filed on Jul. 16, 2001, now U.S. Pat. No. 6,427,359. These applications are incorporated herein by reference.

### BACKGROUND

The semiconductor industry continues to experience more stringent manufacturing requirements to provide ever smaller semiconductor devices and higher density devices. Cleaning such devices continues to be a challenge, as the requirements become more demanding, and environmental concerns place restrictions on the types and amounts of chemical that can be used. Thus, there is a need for continual evolution and new developments in critical cleaning applications in the semiconductor industry.

In the field of semiconductor device cleaning, numerous cleaning sequences and chemicals are well known and commonly used. Cleaning chemistries are applied in various ways, including static immersion, recirculated immersion, aerosols, vapors, and sprays. In addition, energy may be imparted to the cleaning systems in the form of heat, pressure, sonic agitation, and/or electromagnetic radiation. Semiconductor device cleaning is generally accomplished by applying one or more of these cleaning chemistries to semiconductor device wafers. These chemistries are often aqueous-based, and may include inorganic components including, but not restricted to, sulfuric acid, hydrochloric acid, hydrofluoric acid, ammonium hydroxide, hydrogen peroxide, ozone, and hydrogen.

A water rinse, often using de-ionized (DI) water, is typically performed after the chemical cleaning steps. The rinse may be done with pure DI water, or the DI water may include chemical additives, such as HF, HCl, or other compounds that are dissolved into or mixed with the DI water.

Various systems have been designed to deliver the cleaning chemistries. These usually include some form of temperature control, and may also include using sonic energy or electromagnetic radiation.

Sonic or megasonic cleaning technology has been widely used in the semiconductor industry, due to its proven capability to remove contaminant particles and enhance certain cleaning applications. This reduces process time and/or the chemical concentration required to perform a given operation. These advantages from use of sonics are generally believed to result from the increase in energy in the system; the development of acoustic streaming; the thinning of surface boundary layers; the more rapid exchange of fluids within the boundary layers; the evolution of ionic species within the processing fluid, and/or the prevention of redeposition of contaminants. Moreover, even megasonic agitation of DI rinse tanks has been shown to improve cleaning performance.

Following the cleaning and rinse processes, the wafers typically undergo a drying process. The drying is generally controlled to reduce or prevent contaminating particles and residues from depositing or remaining on the semiconductor device surfaces. The drying must be complete in order to ensure that water drops are not left behind to evaporate. Evaporation can lead to the deposition of contaminants on the device, or may alter the surface characteristics of the device, thereby ultimately causing device failure or degraded performance.

Historically, drying techniques have included the spin-rinse-dry (SRD), Isopropyl Alcohol (IPA) vapor dry, vacuum assisted dry, down-flow drying, direct-displacement drying, and a technique termed the Marangoni dry or Marangoni effect. In the Marangoni dry, or Surface Tension Gradient (STG) dry method, an organic vapor of a liquid having a low surface tension is introduced in vapor form to a chamber wherein semiconductor wafers are immersed in a rinse water solution. The organic vapor dissolves in the surface film of the rinse solution, thereby reducing the surface tension in the surface film.

The wafers are then either slowly raised up out of the rinse solution, or the rinse solution is slowly drained out of the bottom of the process vessel, allowing the liquid/gas interface to pass across the wafer surface. Since fluids tend to flow from a region of low surface tension into a region of high surface tension, the rinse liquid is pulled from the surface of the wafer and from the device features on the wafer, leaving behind a dry surface.

Generally, megasonic agitation, if used, has been discontinued before the wafers are removed from the rinse solution, or before the aqueous rinse solution is drained from the process vessel. Thus, megasonic agitation has not been used during the wafer-drying process, and the cleaning and drying processes have traditionally remained separate from one another. This has resulted in relatively long process times, as well as use of larger volumes of chemicals for processing. As a result, certain existing processing techniques have been time-consuming and costly. Additionally, the large chemical quantities used must be disposed of, after processing is completed, in a safe ecological manner, which also requires significant time and expense.

Accordingly, there is a pressing need for improved methods for cleaning and drying semiconductor wafers in more efficient and effective ways.

### SUMMARY OF THE INVENTION

New techniques for cleaning and drying wafers have now been invented. These techniques provide significantly improved results. Specifically, these newly invented techniques or methods allow for faster cleaning and drying, a more effective cleaning approach producing wafers at a higher level of clean, and at the same time, use less cleaning and drying chemicals and water. These new methods, referred to here as “comprehensive cleaning” use sonic agitation in the drying process.

The invention in general terms involves a method of processing a semiconductor workpiece by immersing the workpiece in an aqueous solution in a process vessel. Sonic agitation is provided to a surface of the workpiece. An organic vapor is delivered to a region above the surface of the aqueous solution to create a reduced surface tension at the surface of the aqueous solution. The workpiece is lifted out of the aqueous solution at a controlled rate. Sonic agitation continues to be provided as the workpiece is lifted.

In another separate form of the invention, the aqueous solution is drained from the process vessel at a controlled rate. The liquid level drops down across the workpiece surface, instead of the workpiece being raised out of the aqueous solution. The aqueous solution may be drained out of an opening at or near the bottom of the process vessel, or through openings in a porous wall of the process vessel.

While batch mode processing is preferred, the methods may also be used on single wafers or workpieces. The workpieces are preferably vertical or upright as the methods are performed.

Other features and advantages of the invention will appear hereinafter. The invention resides as well in sub-combinations of the features described, and in the system and apparatus for performing the methods described above.

### BRIEF DESCRIPTION OF THE DRAWING

FIG. 1 is a schematic view of a processing system used to perform wafer processing methods according to a preferred embodiment.

### DETAILED DESCRIPTION

In a method of cleaning and drying a workpiece, ultrasonic sonic or megasonic agitation (collectively referred to here as “sonic agitation”) is applied to the workpiece during a Marangoni or surface tension gradient (STG) drying step, such that the cleaning and drying steps are combined into a comprehensive process. Other steps and features described below may be advantageous but are not necessarily essential to the invention. Workpiece, wafer or semiconductor wafer here means any flat media, including semiconductor and other substrates or wafers, glass, mask, and optical memory media, MEMS substrates, or any other workpiece having micro electronic, micro mechanical, or electro mechanical devices.

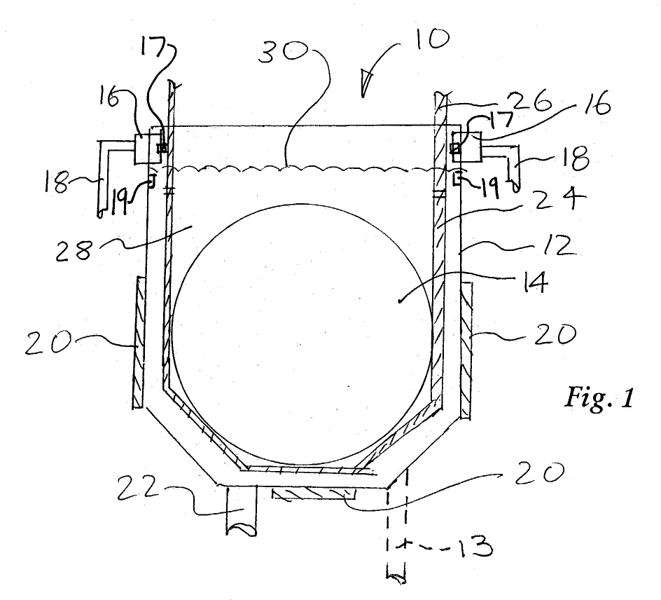

FIG. 1 illustrates a processing system 10 that may be used to process semiconductor workpieces or wafers according to a preferred embodiment. The processing system 10 includes a process vessel 12 in which one or more wafers 14 are processed. At least one fluid delivery manifold 16 is preferably included in the process vessel 12 for delivering liquid, gas, and/or vapor into the process vessel 12. Each fluid delivery manifold 16 may have one or more delivery ports or nozzles, each preferably connected to a fluid supply line 18. The fluid supply lines 18 lead into the process vessel 12 from one or more fluid supply reservoirs (not shown in FIG. 1).

One or more sonic transducers 20 are preferably located on the bottom and/or the sides of the interior of the process vessel 12. A drain 22, or other opening, is also preferably located at or near the bottom of the process vessel 12. The one or more wafers 14 preferably rest on a workpiece support 24 in the process vessel 12. In a preferred embodiment, the workpiece support 24 is connected to an actuator mechanism 26, which is used to raise the workpieces 14 out of the process vessel 12 at a controlled rate. An example of such an actuator mechanism is described in U.S. Pat. No. 6,192,600 incorporated by reference. The essential elements of the system 10 include the vessel 12, the sonic transducers 20, a means for moving the liquid level across the workpieces, such as the actuator mechanism 26 or the drain 22, and liquid and vapor sources.

The relative positioning of the components, as well as the overall system configuration, may be varied as desired. Thus, the general configuration of the processing system 10 illustrated in FIG. 1 is shown by way of example only.

One deficiency found in existing semiconductor wafer cleaning systems is that the cleaning steps are separated from the drying step. As a result, the cleaning and drying processes are often time-consuming and expensive. Wafers must be sufficiently dried before they can be subjected to further processing steps. Thus, the drying process is critical. One aspect of the invention is that the drying step is incorporated into or performed with, or in the same vessel or chamber, as the cleaning process. This provides a comprehensive cleaning and drying process, allowing processing efficiency to be increased, and costs significantly reduced.

In a preferred method of performing a comprehensive cleaning and drying process, the process vessel 12 is filled with an aqueous rinse solution 28, via one or more fluid supply lines 18 supplying one or more manifolds 16 with fluid. The aqueous rinse solution 28 is preferably maintained at a temperature between 15° C. and 300°, but higher and lower temperatures may be used for certain applications. The fluid 28 may alternatively be pumped into the vessel 12 through a bottom or lower inlet 13, or through spray nozzles or openings 17 in the vessel 12, with or without use of a manifold 16.

The aqueous rinse solution 28 preferably, but not necessarily, includes de-oxygenated water. The aqueous rinse solution may also include certain additives for the purpose of cleaning or passivating the wafer surfaces. Such additives might include HF, HCl, H₂O₂, NH₄OH, ozone, hydrogen, chelating agents, or other suitable substances. Such additives, if employed, are preferably very dilute, from a low of approximately 1 ppm for hydrogen, to a high of approximately 30% for hydrogen peroxide.

One or more wafers or workpieces of any type 14 are immersed in the aqueous rinse solution 28, either by lowering the actuator mechanism 26 supporting the wafers 14 into the rinse solution 28, or by placing the wafers 14 into a stationary wafer holder within the process vessel 12 and raising the level of the rinse solution. The wafers may be held and transported in a conventional carrier, a minimal cross-section carrier, a robot end-effector, or any other suitable wafer holding device such as a cassette. The wafers may be loaded manually or by a robot.

Once the wafers 14 are immersed, sonic agitation is preferably provided via the sonic transducers 20 in order to: (a) minimize the surface boundary layer on each wafer; (b) promote a rapid exchange of fluid within the boundary layer; and/or (c) to minimize the adhesion and/or redeposition of contaminants to the surface of the wafer 14. The process vessel 12 is preferably configured to minimize reflected energy so as to preserve the operational life of the sonic transducers 20.

The power supplied by the sonic transducers 20 is regulated to prevent excessive agitation of the liquid surface. Excessive agitation may result in the formation of aerosol droplets that deposit on the wafers 14 as a liquid-gas interface passes across the wafers 14. The deposition of aerosol droplets constitutes a contaminant, which could be detrimental to device performance.

Once the sonic agitation has begun, one or more organic vapors are delivered into the vessel 12, for example, from at least one of the fluid delivery manifolds 16, to a region above the rinse liquid surface 30. These vapors may include isopropyl alcohol (IPA), methanol, acetone, or any other relatively volatile organic compound having a liquid form with a surface tension lower than that of water at a given processing temperature. Additionally, gasses having a relatively high solubility in water could be used. These may include CF₄, CO₂, and/or other suitable gases. The objective is to have a gas or vapor dissolve in the surface film of the rinse liquid, thereby reducing the surface tension of the liquid at the surface 30. This creates a surface tension gradient necessary to pull liquid from the wafer surface as a liquid-gas interface passes across the wafer 14.

Vapor is preferably generated in order to provide a quantity of organic vapor, or other surface tension reducing agent, to the liquid surface 30 in the rinse tank, in one or more different ways. By doing so, the surface tension in a thin liquid-gas/vapor boundary layer formed at the surface 30 of the aqueous liquid 28 is reduced. Vapor may be generated, in a separate apparatus or vessel by: (a) passing a carrier gas, such as nitrogen, across the surface of an organic solvent; (b) bubbling a carrier gas, such as nitrogen, through the surface tension reducing liquid or an organic solvent; chamber; (c) evaporating a quantity of a surface tension reducing agent or organic solvent; (d) sonically agitating a quantity of the surface tension reducing agent or organic solvent; (e) and/or creating a finely dispersed aerosol; or other suitable techniques, and, in each case, pumping or conveying the vapor to the vessel 12. The vapor generator described in U.S. Pat. No. 6,319,814, incorporated herein by reference, may also be used.

The liquid-gas/vapor interface created at the liquid surface 30 moves across the wafer surface by either: (a) raising the wafers 14 up out of the process vessel 12 at a controlled rate via the actuator mechanism 26, or (b) draining the rinse fluid 28 at a controlled rate while the wafers 14 remain substantially stationary. Fresh rinse fluid is preferably continuously delivered to the process vessel 12 while the liquid-gas/vapor interface passes over the wafer surface, in order to replenish the liquid surface 30 with clean fluid.

To this end, withdrawing the wafers 14 from the liquid 28 may be preferred to draining the liquid 28 from the vessel 12. Withdrawing the wafers, rather than draining the liquid, generally better prevents a buildup of particles at the liquid surface 30. For example, if a process vessel with a top overflow configuration is used, the liquid surface 30 will continually flow out the top of the vessel and be replenished by fresh rinse water. As a result, particles and contaminants flow out of the process vessel 12 with the overflow water, and fresh rinse water replenishes the liquid surface 30.

If draining is employed, the draining may be accomplished by allowing the liquid 28 to flow out the opening or drain 22 in the bottom of the process vessel 12. Alternatively, draining may be performed by lowering a vessel wall or section of the wall and allowing the fluid to flow out through the gap created by the lowering of the wall, as described in U.S. Pat. No. 6,427,359, incorporated herein by reference. Alternatively, a vessel with a porous wall as described in U.S. Pat. No. 6,502,591, incorporated, herein by reference, may be used to drain the aqueous liquid 28 out through pores 34 in the vessel wall 32. Referring to FIG. 1, fresh liquid may be pumped in through the inlet 13 or the inlets or nozzles 17, with liquid at the surface 30 drained off through slot or other openings 19 in the walls of the vessel 12, or over the top edges of the vessel 12.

When draining is used, the flow rate of liquid 28 into the process vessel 12 must be lower than the flow rate of liquid 28 out of the process vessel 12, so that the surface tension gradient remains intact. When using a porous vessel, the drain rate may be controlled by pressurization of the processing environment or vessel, such that liquid flows into the vessel at a lower rate than it flows out through the pores 34 in the vessel. The rate at which the liquid-gas/vapor interface passes across the wafer 14, whether caused by draining or withdrawing the wafers 14, is controlled to allow the surface tension to pull liquid from the microscopic features on the semiconductor device. This rate is preferably between 0.5-10 or 20 mm/second, or 1-10, 2-8, or 4-6 mm/second.

Sonic agitation is continued during the period that the liquid-gas/vapor interface passes over the wafer surface. The reduction in surface tension, coupled with sonic agitation, at the interface minimizes particle and contaminant adhesion and redeposition. As a result, the wafer 14 is effectively cleaned via sonic agitation during the drying process. Additionally, the cleaning performance is enhanced, since contaminants tend to be entrained in the liquid film and are unable to make the transition to the dry wafer surface. This effect is further enhanced by continually refreshing the liquid surface via the described overflow rinse configuration, or porous wall configuration, wherein fresh rinse fluid is continuously delivered to the rinse tank while the liquid-gas/vapor interface passes over the wafer surface.

By continuing sonic agitation during the drying process, the need for separate cleaning and drying steps is eliminated. Moreover, because the sonic gradient is maintained throughout the comprehensive cleaning and drying process, cleaning of the wafers 14 is significantly enhanced. The combination of applying sonic energy during the surface tension gradient drying, provides improved results.

Further cleaning improvements may be achieved by irradiating the wafers during the comprehensive cleaning and drying process, in order to: (a) energize the system; (b) alter or passivate the wafer surfaces; (c) heat the wafer surfaces to enhance the surface tension gradient by means of thermocapillary action as described, for example, in U.S. Pat. No. 6,401,732, incorporated herein by reference; and obtain other benefits resulting from irradiation.

The methods described offer the advantages of coupling the drying step to the cleaning steps in the manufacture of semiconductor and similar devices. As a result, cleaning performance is enhanced, enabling the application of such technology to increasingly smaller devices. Process times are also reduced due to the combination of process steps. Additionally, chemical consumption is reduced, thereby lowering costs and increasing ecological benefits.

While embodiments and applications of the present invention have been shown and described, it will be apparent to one skilled in the art that other modifications are possible without departing from the inventive concepts herein. The invention, therefore, is not to be restricted except by the following claims and their equivalents.

What is claimed is:

1. A method of cleaning and drying one or more workpieces, comprising the steps of:
immersing the workpiece in an aqueous solution in a process vessel;
providing sonic agitation into the aqueous solution;
delivering an organic vapor to a region above a surface of the aqueous solution to create a reduced surface tension at the surface of the aqueous solution;
raising the workpiece out of the aqueous solution at a controlled rate, causing a liquid-vapor interface to pass across the workpiece surface; and
continuing sonic agitation while the liquid-vapor interface passes across the workpiece surface.

2. The method of claim 1 further comprising the step of irradiating the workpiece.

3. The method of claim 1 further comprising the step of delivering the organic vapor with a carrier gas.

4. The method of claim, further comprising the step of controlling the temperature of the aqueous solution.

5. The method of claim 1 wherein the workpiece are. held in a vertical orientation.

6. The method of claim 1 wherein the sonic agitation is provided to the workpiece through the aqueous solution from one or more sonic transducers on a surface of the process vessel.

7. The method of claim 1 wherein the controlled rate of raising is from 0.5 mm/s to 10 mm/s.

8. The method of claim 4 wherein the aqueous fluid is provided at a temperature of 15° C. to 30° C.

9. The method of claim 1 wherein the aqueous solution includes at least one additive selected from the group consisting of HF, HCl, H₂O₂, NH₄OH, O₃, and H.

10. The method of claim 1 wherein the organic vapor is selected from the group consisting of isopropyl alcohol, methanol, acetone, CF₄, and CO₂.

11. The method of claim 1 further comprising the step of continuously delivering fresh aqueous solution to the process vessel to continually refresh the surface of the aqueous solution.

12. The method of claim 1 further comprising the step of supporting multiple workpieces in the process vessel.

13. A method of cleaning and drying one or more workpieces, comprising the steps of:
immersing the workpiece in an aqueous solution in a vessel;
providing sonic energy into the aqueous solution;
delivering an organic vapor into the vessel to create a reduced surface tension at the surface of the aqueous solution;
removing the aqueous solution from the vessel at a controlled rate with the liquid-vapor interface moving down across the workpiece surface; and
continuing to provide sonic energy into the aqueous solution while the liquid-vapor interface moves down across the workpiece surface.

14. The method of claim 13 wherein the workpiece remains substantially stationary during the draining step.

15. The method of claim 13 wherein the aqueous solution is removed via a drain opening in a lower region of the process vessel.

16. The method of claim 13 wherein the aqueous solution is removed through a porous wall in the process vessel.

17. The method of claim 16 further comprising the step of pressurizing an interior region of the vessel.

18. The method of claim 13 wherein the controlled rate of draining is from 0.5 mm/s to 10 mm/s.

19. The method of claim 13 further comprising the step of irradiating the workpiece.

20. The method of claim 13 further comprising the step of continuously delivering fresh aqueous solution to the vessel to refresh the surface of the aqueous solution.

21. A method of processing a workpiece, comprising the steps of:
immersing the workpiece in an aqueous solution in a process vessel;
providing sonic agitation to a surface of the workpiece;
delivering an organic vapor to a region above a surface of the aqueous solution to create a reduced surface tension at the surface of the aqueous solution;
removing the workpiece from the aqueous solution at a controlled rate such that a liquid-vapor interface at the surface of the aqueous solution passes across the workpiece surface; and
continuing sonic agitation while the liquid-vapor interface passes across the workpiece surface.
